(19) United States
(12) Patent Application Publication
(10) Pub. No.: US 2006/0098632 A1
(43) Pub. Date: May 11, 2006

(54) System and method for integrated distribution of broadband services

(76) Inventor: William Arthur Johnson, Plano, TX (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/268,225

(22) Filed: Nov. 7, 2005

Related U.S. Application Data
(60) Provisional application No. 60/626,044, filed on Nov. 8, 2004.

(51) Int. Cl. H04L 12/66

(52) U.S. Cl. 370/352

(57) ABSTRACT

A system and method for establishing a virtual point-to-point communication connection is described. One embodiment of the system includes a communication interface configured to receive communications data originated from a customer premise device, wherein the communication interface is connectable to the customer premise device through a first virtual path; a packet switch connected to the customer interface, the packet switch configured to receive the communications data from the customer interface; a switch-router configured to receive the communications data from the packet switch, the switch-router connectable to the packet switch by a second virtual path; and a multi-protocol, class 5 switch connected to the switch router; wherein the virtual-point-to-point connection is established between the customer premise equipment and the switch-router using the first virtual path and the second virtual path.

### PRIORITY

The present application claims priority from to commonly owned and assigned application No. 60/626,044 Attorney Docket No. SAVA-001/00US, entitled SYSTEM AND METHOD FOR INTEGRATED DISTRIBUTION OF BROADBAND SERVICES, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to communications networks.

### BACKGROUND OF THE INVENTION

Telecommunication networks generally fall into two categories: enterprise and public. The two network designs have greatly differing requirements. First, the enterprise network design considers a closed working group with a reasonably accurate estimate of the number of employees who will be using the network today, and in the foreseeable future. In addition, software operating systems are generally standardized, and adding or changing network administrators typically solves quality problems (no one pays a monthly bill and there is no competition). Finally, enterprise networks do not have to meet “carrier class” requirements; those requirements that mandate high network availability and emergency 911 services. By contrast, a public network has an open user community, users operate a myriad of hardware and software systems, and critical network requirements must be maintained for mission critical business services.

Over the past several years, enterprise network designs, such as the well know Internet Protocol (IP) network, have been making their way into the public network domain and have caused serious problems for the user community, especially when trying to determine the end-to-end performance of such a network.

Network architectures, such as an all Internet Protocol (IP) network, use one protocol (IP) to transport voice, data, and video services. These single protocol systems (e.g., IP) require mapping and re-mapping of native rate services into IP, each translation process incurs cost and adds complexity (possible failure points) to the network architecture. Although these device types are functional, they are not sufficiently flexible, fast, or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

One embodiment of the system includes a communication interface configured to receive communications data originated from a customer premise device, wherein the communication interface is connectable to the customer premise device through a first virtual path; a packet switch connected to the customer interface, the packet switch configured to receive the communications data from the customer interface; a switch-router configured to receive the communications data from the packet switch, the switch-router connectable to the packet switch by a second virtual path; and a multi-protocol, class 5 switch connected to the switch router; wherein the virtual-point-to-point connection is established between the customer premise equipment and the switch-router using the first virtual path and the second virtual path.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of one embodiment of a system in accordance with the ideas of the present invention;

FIG. 2 is a block diagram showing one method for integrating the fixed-wireless network with the ATM optical line terminal (OLT);

FIG. 3 is a block diagram showing one method for extending a fiber-optic connection over a microwave radio using the ATM OLT;

FIG. 4 is a block diagram showing some of the methods of providing backhaul from the ATM OLT to the central office; and

FIG. 5 is a block diagram of one embodiment of the central office.

### DETAILED DESCRIPTION

Embodiments of the present invention include an enhanced broadband network (EBN), which comprises a “carrier class” network designed to operate in the public domain. Embodiments of the EBN can provide automated end-to-end quality of service (QoS) measurements that are used to validate customer service level agreement (SLAs). Embodiments can also include a software layer, which permits customer control of virtually all of his or her products and services in near real-time over the EBN. The EBN can be implemented so that it bypasses the incumbent local exchange carrier (ILEC), and provides a group of integrated technologies capable of serving all residential and business market segments. In addition, the EBN can provide all necessary features for 911 service, CALEA wiretap functionality, and CENTREX services for business applications.

While other network architectures, such as an all Internet protocol (IP) network, use one protocol (IP) to transport voice, data, and video services, the EBN can be protocol transparent. Whereas a single protocol system (e.g., IP) requires mapping and re-mapping of native rate services into IP, each translation process incurs cost and adds complexity (possible failure points) to the network architecture. By contrast, embodiments of the EBN are capable of taking any protocol (e.g., IP, frame relay, TDM, VoIP, ATM, etc.) and cross-connecting each protocol across the network architecture, enclosed in, for example, an asynchronous transfer mode (ATM) pipe.

One embodiment of the present invention integrates fixed-wireless, point-to-point microwave, and fiber-optic technologies together with an Intranet-based, highly-secure, operation support system. This network architecture can provide a complete portfolio of telecommunications products and services for residential and small business customers; point-to-point microwave, and fiber-to-the-node (FTTN) capabilities for medium, large, and extra large business; and Greenfield residential fiber-optic applications. These different applications are discussed below.

Fixed-Wireless Technology

One embodiment of the EBN incorporates wideband-code division multiple access (wideband-CDMA)—although other protocols can easily be used—to achieve a facility-based network infrastructure capable of rapid deployment in a non-line-of-site environment. Internet protocol (IP) can be employed in a standards-based architecture for both voice and data applications. Enabled for quality of service (QoS), IP provides support for differentiated levels of service in the network, including toll-quality voice. Current wideband-CDMA technology is generally insufficient to meet the market demand for broadband data. In actual fully loaded standard wideband-CDMA networks, subscribers experience data throughput around 100-200 Kbps. This falls far short of market expectations for broadband service.

Within the bandwidth-constrained wireless environment, the wireless portion of this EBN embodiment offers an air interface that incorporates QUALCOMM CDMA technology that has significant enhancements to improve capacity many times over. Again, other protocols can be used to achieve similar results.

Leveraging many facets of the air interface, distributed software provides another multiple of capacity gain by turning the “dumb pipe” model of a basic wireless network into a “smart pipe” model used in the chosen solution. Instead of mindlessly passing traffic through at the transport layer, the wireless network can peer into the transport, IP, and application layer of all traffic. This provides substantial potential to optimize traffic through a wide variety of techniques including data compression, header minimization, and many other techniques.

As a result, the wireless network of this embodiment combines air interface and distributed software techniques, increasing system capacity by more than an order of magnitude over that found in basic wireless systems, delivering up to 12 Mbps peak sector rates and enabling multi-megabit individual service performance. Additionally, the wireless platform can provide management of network traffic based on different network layers, media type, and quality of service (QoS) requirements.

To deliver macro cell coverage and strong non-line-of-site performance, a wireless network must respond to many anomalies that occur during the transmission of high frequency microwave signals. Radio signals grow weaker over distance. Additionally, objects such as trees, hills, buildings, and walls all cause radio signals to incur path loss. As path loss increases, radio energy decreases, reducing the amount of data that can be received. In addition, because radio waves bounce, the receiving antenna may detect multiple fragments of the signal at any time. Coverage, therefore, is much more that just signal detection; it is a question of service capability at high levels of path loss. This embodiment of the wireless network is capable of delivering broad geographic coverage in the industry while still delivering full megabit service with greater than 160 dB path loss. Advanced radio frequency techniques such as a custom feed-forward power amplifiers in the macro base station, a passive steered-array antenna in the customer premise equipment, dual antennas in each macro base station sector, tower-top low noise amplifiers, and/or scalable cell sites from one to six sectors can all play a roll in achieving the proper quality.

The ability to efficiently deliver a wide variety of applications over a wireless network generally requires a highly complex air interface as well as software techniques. This enables capabilities that significantly increase revenues and lower costs. Accordingly, the wireless network has an air interface that offers substantial advances beyond standard wideband-CDMA that enable not only connectionless broadband data services, but connection-oriented landline-quality voice telephony as well. This enables a single system to deliver both landline-quality voice and multi-megabit broadband, eliminating the multiple-system requirement faced by wireline infrastructure operators. Other advancements within the air interface contribute significantly to the capability of the system.

The software components pick up where the air interface leaves off by peering into the transport, IP and application layers of network traffic. This enables the software platform to treat voice differently from data, as well as to enable subscriber-specific quality of service (QoS) level functionality. It also enables PC-like applications, such as firewall and virus scanning, to run efficiently in a wireless environment.

Operating expenses can be reduced due to the wireless network capabilities. Truck rolls are eliminated for installation, provisioning, and maintenance. Because all of the services enabled on the wireless network are software-generated on the fly, service can be instantly activated and instantly changed with the click of the subscriber's mouse. Software upgrades are pushed to the subscriber terminal, ensuring high-quality services and a common operating environment among all subscribers. Finally, maintenance personnel can remotely access each subscriber terminal, which eliminates truck rolls for this business expense.

Security is a major concern when using any network, wireless or wireline. CDMA is considered by the industry to be the most secure means for wireless transmission. CDMA scrambles the entire radio spectrum, and then assigns each individual end-user a specific de-scrambling code.

Enhanced Broadband Network Protocol

One embodiment of the EBN incorporates asynchronous transfer mode (ATM) protocol. The ATM based network architecture is essentially transparent to all types of traffic: voice, data, video, etc. All traffic entering the ATM network is sliced into small 53-byte cells before it is transmitted over the EBN. Each cell has 5-bytes of overhead, leaving 48 bytes for revenue bearing traffic. When traffic enters the network in a non-ATM format, it is converted to cells by means of a process called encapsulation. As it exits the network on the distant end, it is converted back to its original format by a reverse process know as de-encapsulation. This cell process is generally accomplished in hardware and adds very little latency to the information as it passes across the network.

Different traffic has different requirements and those requirements are met by prioritizing cells in the ATM network. Voice and video generally require a constant bit-rate; therefore, an ATM service referred to as constant bit-rate (CBR) is selected for voice and video transmission. ATM reaches into the cell stream and structures a specific lineup of cells that are given high priority for these services. Data services, which are variable in structure and typically are not time sensitive, use another service referred to as variable bit-rate (VBR). If a voice over Internet protocol (VoIP) call is placed over the network, it requires yet another class of service. While it is data, it carriers voice, which must be transmitted in real-time or delay will be interjected into the call causing echo. In this case, a real-time, variable bit rate service (rt-VBR) is selected within the ATM cell path and a virtual circuit is tailored to the VoIP requirements. The ATM structure also contains several other lower priority services that may be used for non-priority traffic.

The ATM optical line terminal (OLT) serves as a universal concentrator for the EBN. Using various standard interfaces, the OLT integrates the fixed-wireless network and a number of fiber-optic products including fiber-to-the-home, fiber-to-the-business, and an assortment of microwave subscriber and backhaul technologies.

The fixed-wireless portion of the network effectively inherits the attributes of the ATM OLT thereby providing one seamless network that automatically produces the detailed information required for billing, provisioning, and network management.

Central Office

The central office (CO), in one embodiment, is a scalable IP+ATM switch/router used to process all data traffic. The term central office also encompasses other types of central office systems and is not meant to be limited to the configuration described herein. Those of skill in the art will understand that the term has significant breadth.

The CO, in one embodiment, contains a class-5 softswitch for processing voice calls using any of three protocols: voice over Internet protocol (VoIP), voice over time division multiplex (VoTDM), and voice over asynchronous transfer mode (VoATM). The voice and data switching architecture is inexpensive and can meet the price points required for low margin residential and small business customers while providing the advanced features (CENTREX) required by the largest business customers.

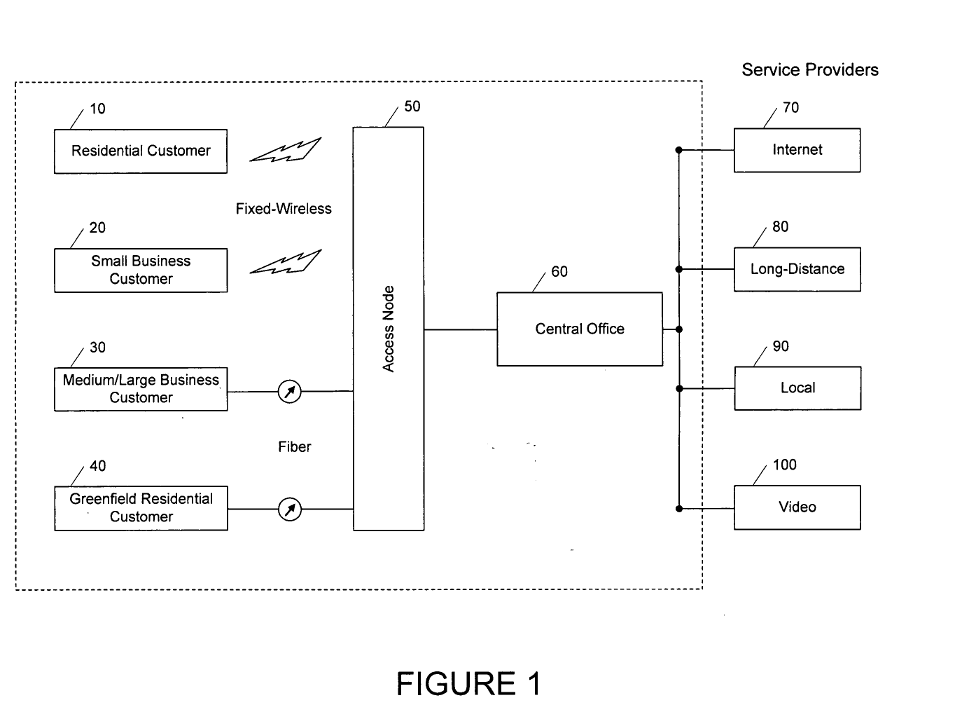

FIG. 1 shows a high-level, end-to-end method for connecting fixed-wireless and fiber-optic customers to various service providers. Residential customers 10 and small business customers 20 are connected to an access node 50 using wideband-CDMA fixed wireless technology. Medium and large business customers 30 and Greenfield residential customers 40 are connected to the same access node 50 by means of fiber-optic connections. These customers can be linked to the access node 50 through a virtual path.

All fixed-wireless and fiber-optic traffic is then integrated into a stream of ATM packets in the access node 50 and sent to the central office 60 where voice, data, and video multimedia services are processed for delivery to various service providers including Internet 70, long-distance 80, other local carriers 90, and video service providers 100. The connection between the access node 50 and the central office 60 is a virtual path. Together, the virtual path between access node 50 and the central office 60 and the virtual path between customers and the access node 50 for a virtual point-to-point connection between the customer and the central office 60.

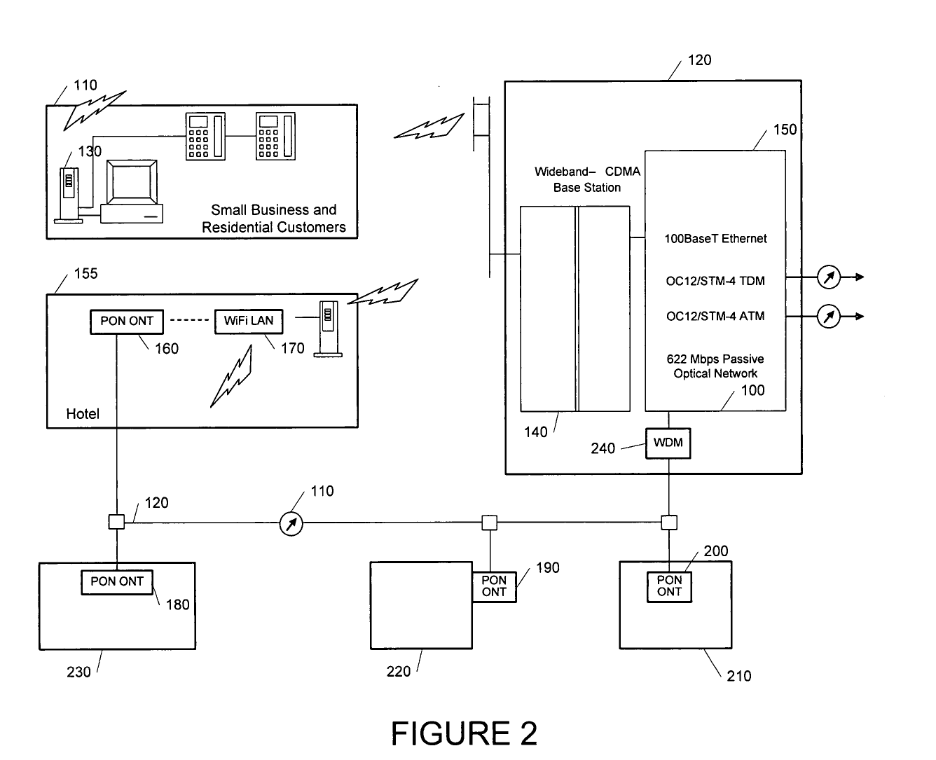

FIG. 2 shows detailed connectivity between various residential and business customers 120 and access node 120. The fixed-wireless customer premise equipment 130 transmits and receives signals from wideband-CDMA base station 140 that is located in access node 120. The output of the wideband-CDMA base station 140 connects to the 100BaseT Ethernet connection on the ATM optical line terminal 150. This Ethernet signal is encapsulated in the ATM optical line terminal 150 that in turn connects to the central office (not show in this drawing) over SONET/SDH link.

FIG. 2 also illustrates a hotel 155 WiFi application, whereby fixed-wireless customer premise equipment 160 connects to WiFi LAN switch 170. Depending on the size of WiFi LAN switch, ten to several hundred WiFi customers can be served. Fixed-wireless customer premise equipment transmits and receives signal to wideband-CDMA base station 140 located in access node 120. The output of the wideband-CDMA base station 140 connects to 100 BaseT Ethernet connection on ATM optical line terminal 150. This Ethernet signal is encapsulated in the ATM optical line terminal 150 that in turn connects to the central office (not show in this drawing) over SONET/SDH link.

One example of various fiber-optic applications is also shown in FIG. 2. A single strand of fiber-optic cable 110 connects to a passive optical network (PON) connection on the ATM optical line terminal 150 that is located in access node 150. Each fiber-optic customer is connected to the single strand of fiber-optic cable by means of passive optical splitter that in turn connects to optical network terminal (ONT) 180, 190, 200.

Given that the fiber-optic network is passive, no curbside enclosures containing active inline electronics are required. All voice, data, and streaming video information from, for example, medium size business customer 210, Greenfield residential customer 220, and large business customer 230 flow to the ATM optical line terminal 150 where data can be encapsulated in ATM cells and then transmitted back to the central office (not shown in this drawing) over SONET/SDH link. As an alternative, an optical network terminal may be used in lieu of fixed-wireless customer premise equipment for WiFi applications such as hotels. A video head-end: analog, digital, or HDTV, can be connected to the wave division multiplex (WDM) filter 240, which in turn will transmit cable TV channels (hundreds) to Greenfield residential customer on a 1550 nanometer overlay channel that is completely independent from the passive optical network.

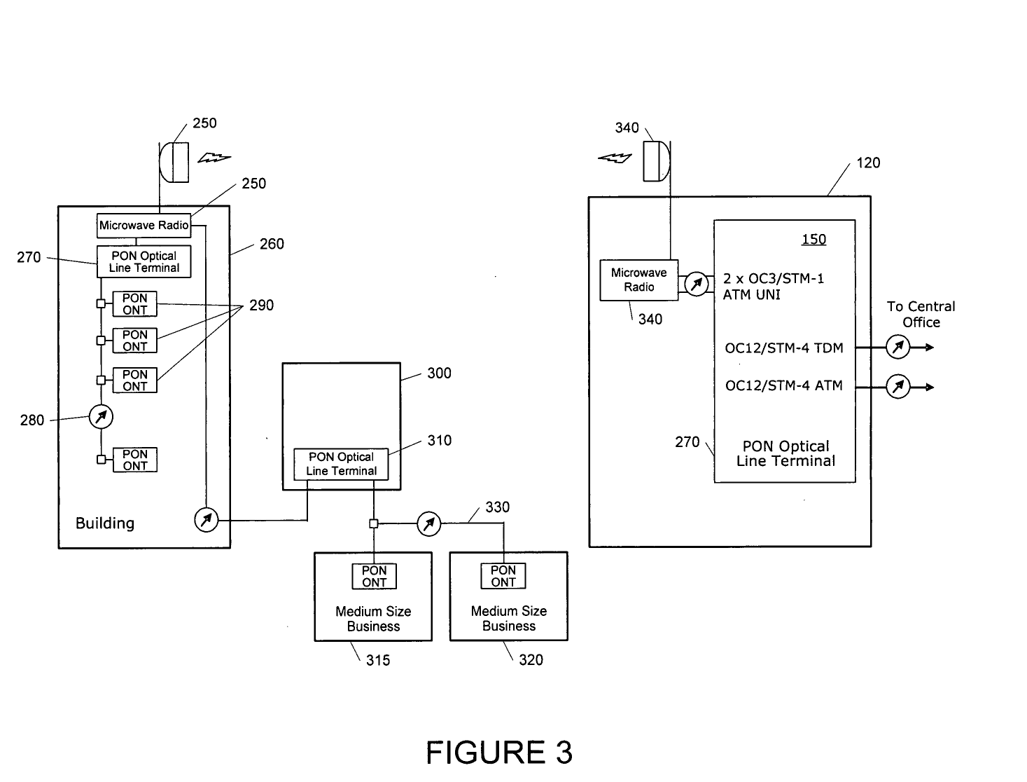

FIG. 3 is a block diagram of a system using microwave radio to extend the capabilities of a passive optical network, where no fiber-optic cable is available. A microwave radio 250, installed on top of building or office complex 260, connects to a remote ATM optical line terminal 270. The optical line terminal 270 connects to several floors in the building by means of fiber-optic cable 280 and passive optical splitters. Splitters are then connected to optical network terminals 290. In the example, microwave radio also connects via fiber-optic cable to a business 300 that contains a second optical line terminal 310. The business optical line terminal 310 then connects to two other businesses 315, 320 and by way of fiber-optic cable 330 and optical splitter.

The customer traffic is then transmitted by means of the point-to-point microwave antenna 250 to the access node 120 where it is received by microwave antenna 340 and microwave radio 340. The microwave radio 340 connects to the optical line terminal 150 by means of an OC3/STM1 SONET/SDH universal network interface (UNI). Microwave traffic is then encapsulated into ATM cells and transmitted to the central office (not show in this drawing) over SONET/SDH link.

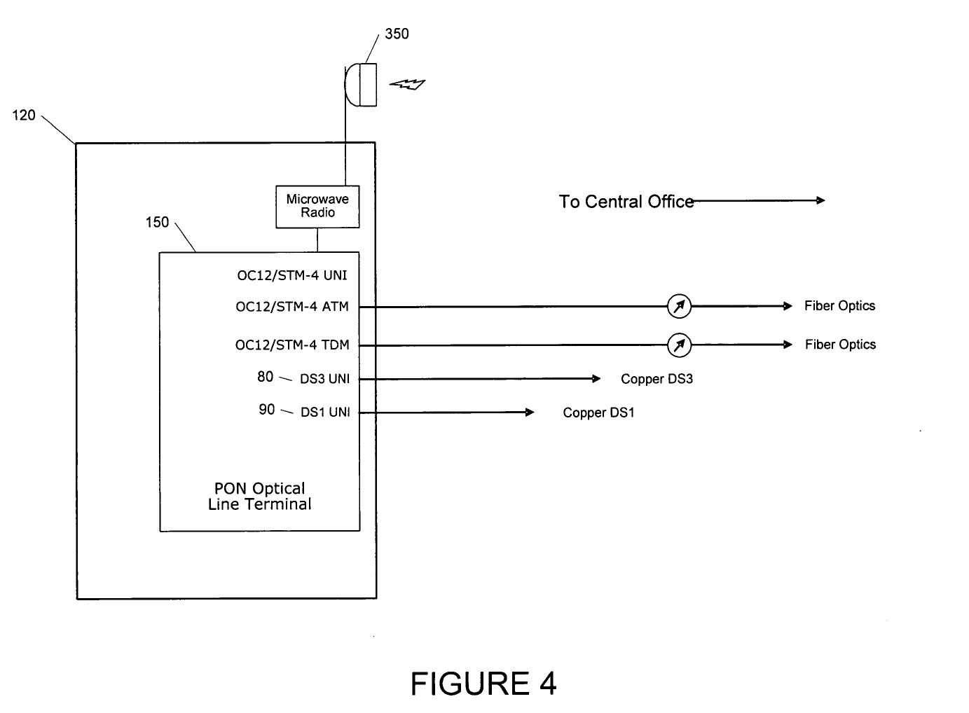

FIG. 4 is a block diagram of the access node 120 showing several systems for backhaul to the central office. The access node 120 contains the optical line terminal 150 that provides an interface to several backhaul technologies. Microwave radio 350 connects to a SONET/SDH universal network interface in optical line terminal 150 providing backhaul to the central office using point-to-point microwave. In addition, the following connections are available on the optical line terminal for backhaul: SONET/SDH asynchronous transfer mode (ATM) over a fiber-optic connection, SONET/SDH time division multiplex (TDM) over a fiber-optic connection, DS3 over copper, and DS 1 over copper.

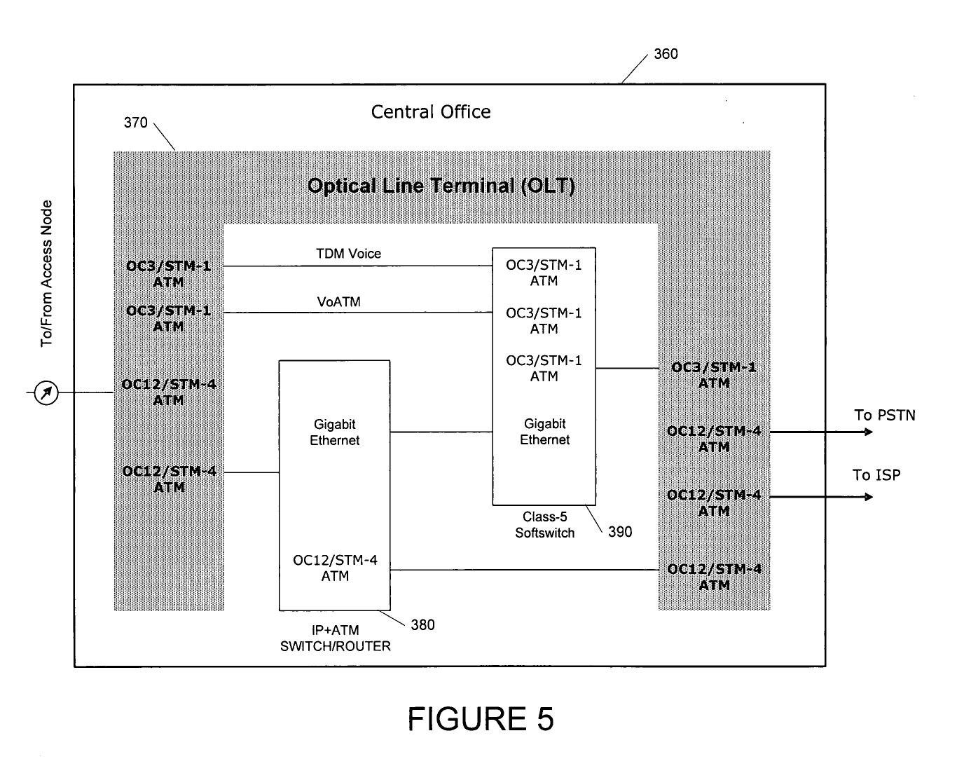

FIG. 5 is a block diagram of one embodiment of an EBN central office 360. This central office consists of three elements. The first, optical line terminal 370 collects and routes all central office incoming and outgoing traffic into the centralized voice and data switching architecture 380, which consist of the following; a high-speed IP+ATM switch/router in this embodiment; and a class-5 softswitch 390 for processing VoIP, VoATM, and VoTDM voice traffic.

Backhaul traffic from one or more access nodes connect to the central office by means of optical line terminal 370 using any transmission media illustrated in FIG. 4 (OC12/STM-4 ATM has been shown in the example). The OC12/STM-4 ATM pipe contains QoS managed traffic (CBR, VBR, rt-VBR, and BE), which in turn is routed to the proper voice and/or data switching architecture.

ATM connectivity is maintained throughout the network (where needed) in order to preserve true end-to-end QoS capabilities, which are used to generate automated service level agreement (SLAs). IP-based traffic is routed from optical line terminal 370 to IP+ATM switch/router 380 over OC12/STM-4 connection. VoIP traffic from both the fixed-wireless and fiber-optic networks is then routed from the IP+ATM switch/router 380 to class-5 softswitch 390 over gigabit Ethernet connection. Gigabit Ethernet is used for this connection since QoS is effectively terminated at the class-5 softswitch 390.

In addition, optical line terminal 370 provides two additional connections to the class-5 softswitch 390; first, VoTDM is connected over OC3/STM-1 connection; and secondly VoATM traffic is connected over OC3/STM-1 connection.

Next, the class-5 softswitch 390 routes voice traffic back into optical line terminal 370 by means of OC3/STM-1 ATM connection, whereby the optical line terminal switching fabric routes the call to the public switched telephone network provider. VoIP Internet service provider, or routes the traffic back into the SNI EBN through connection for private line services. As a final step in the process, IP+ATM switch/router routes IP data traffic over OC 12/STM-4 ATM connection back into the optical line terminal, where the IP traffic is routed to the Internet service provider or routed back into the SNI EBN through OC12/STM-1 connection for private line services.

In conclusion, the present invention provides, among other things, a system and method for transporting information. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A communication system for establishing a virtual point-to-point connection, the system comprising:
a communication interface configured to receive communications data originated from a customer premise device, wherein the communication interface is connectable to the customer premise device through a first virtual path;
a packet switch connected to the communication interface, the packet switch configured to receive the communications data from the communication interface;
a switch-router configured to receive the communications data from the packet switch, the switch-router connectable to the packet switch by a second virtual path; and
a multi-protocol, class 5 switch connected to the switch-router;
wherein the virtual-point-to-point connection is established between the customer premise equipment and the switch-router using the first virtual path and the second virtual path.

2. The system of claim 1, wherein the communication interface comprises:
a point-to-point microwave interface.

3. The system of claim 1, wherein the communication interface comprises:
a point-to-multipoint fixed wireless interface.

4. The system of claim 1, wherein the communication interface comprises:
a point-to-point optical network interface.

5. The system of claim 1, wherein the packet switch comprises:
an Ethernet connection for connecting with the communication interface.

6. The system of claim 1, wherein the packet switch comprises:
an ATM-UNI interface for connecting with the communication interface.

7. The system of claim 1, wherein the packet switch comprises:
an optical line terminal for connecting with the communication interface.

8. The system of claim 1, further comprising:
a wave division multiplex filter connected to the packet switch.

9. The system of claim 8, further comprising:
a video head end in communication with the wave division multiplex filter.

10. A communications system comprising:
a customer premise device;
an access node;
a first virtual path connecting the customer premise device and the access node;
an IP+ATM switch-router; and
a second virtual path connecting the access node and the IP+ATM switch-router.

11. The system of claim 10, further comprising:
a class-5 switch connected to the IP+ATM switch-router.

12. The system of claim 10, further comprising:
a switch for processing voice calls using one of voice over Internet protocol, voice over time division multiplex, and voice over asynchronous transfer mode.

13. The system of claim 10, wherein the first virtual path and the second virtual path form a virtual point-to-point connection between the customer premise device and the IP+ATM switch-router.

14. The system of claim 10, wherein the access node comprises:
a communication interface; and
a packet switch.

15. A communication system comprising:
an access node;
a first virtual path configured to connect a customer premise device and the access node;
a central office; and
a second virtual path connecting the access node and the central office;
whereby the first virtual path and the second virtual path form a virtual point-to-point connection between the customer premise device and the central office.

16. The system of claim 15, wherein the access node comprises:
a communication interface; and
a packet switch.

17. The system of claim 16, wherein the central office comprises:
an IP+ATM switch-router; and
a class 5 switch.
